(19) United States
(12) Patent Application Publication
(10) Pub. No.: US 2007/0172123 A1
(43) Pub. Date: Jul. 26, 2007

(54) Image processing apparatus, image processing method and computer readable medium

(75) Inventors: Hirofumi Komatsubara, Kanagawa (JP); Katsuyuki Kouno, Kanagawa (JP); Kenji Ebitani, Kanagawa (JP); Fujio Ihara, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/525,183

(22) Filed: Sep. 22, 2006

(30) Foreign Application Priority Data
Jan. 25, 2006 (JP) 2006-015852

(51) Int. Cl. G06K 9/34; G06K 7/10

(52) U.S. Cl. 382/175; 382/321

(57) ABSTRACT

An image processing apparatus captures a target image containing marker images and a recognition target range identified by a marker-image set including at least parts of the marker images. The image processing apparatus includes an image capturing section, a first detection section, a position estimation section and a second detection section. The first detection section detects one marker image as a reference marker image from a captured image. The position estimation section adopts a marker image, which is other than the reference marker image and is contained in at least one of marker-image sets containing the reference marker image, as a corresponding marker image. The position estimation section estimates a position of the corresponding marker image in the captured image based on a size of the detected reference marker image. The second detection section detects the corresponding marker image based on the estimated position of the corresponding marker image.

### BACKGROUND

1. Technical Field

This invention relates to an image processing apparatus, an image processing method, and a computer readable medium storing a program for performing image processing for a captured image obtained by capturing a target image.

2. Related Arts

There is a technique of acquiring a captured image by capturing a target image formed on a medium such as a sheet of paper and extracting information from the captured image with an image processing apparatus including an image capturing device such as a mobile telephone or a digital camera. Such an image processing apparatus can capture the target image containing an image area (recognition target range) representing a two-dimensional code, such as a bar code or a QR code (registered trademark), and text, and execute recognition processing on the recognition target range such as analyzing code information and performing OCR processing on the recognition target range. Thereby, the image processing apparatus can acquire digital data represented by these codes.

### SUMMARY

According to an aspect of the invention, an image processing apparatus captures a target image containing plural marker images and a recognition target range identified by a marker-image set including at least parts of the marker images. The image processing apparatus includes an image capturing section, a first detection section, a position estimation section and a second detection section. The image capturing section captures the target image to obtain a captured image. The first detection section detects one marker image as a reference marker image from the captured image. The position estimation section adopts a marker image, which is other than the reference marker image and is contained in at least one of marker-image sets containing the reference marker image, as a corresponding marker image. The position estimation section estimates a position of the corresponding marker image in the captured image based on a size of the detected reference marker image. The second detection section detects the corresponding marker image based on the estimated position of the corresponding marker image.

### BRIEF DESCRIPTION OF THE DRAWINGS

Exemplary embodiments of the invention will be described in detail based on the following figures, wherein:

FIG. 1 is a block diagram to show the schematic configurations of an image processing apparatus according to an exemplary embodiment of the invention;

FIG. 2 is a functional block diagram to show the functions of the image processing apparatus according to the exemplary embodiment of the invention;

FIG. 3 is a drawing to show examples of a target image captured by the image processing apparatus according to the exemplary embodiment of the invention and a captured image provided by capturing the target image; and

FIG. 4 is a flowchart to show an example of processing executed by the image processing apparatus according to the exemplary embodiment of the invention.

### DETAILED DESCRIPTION

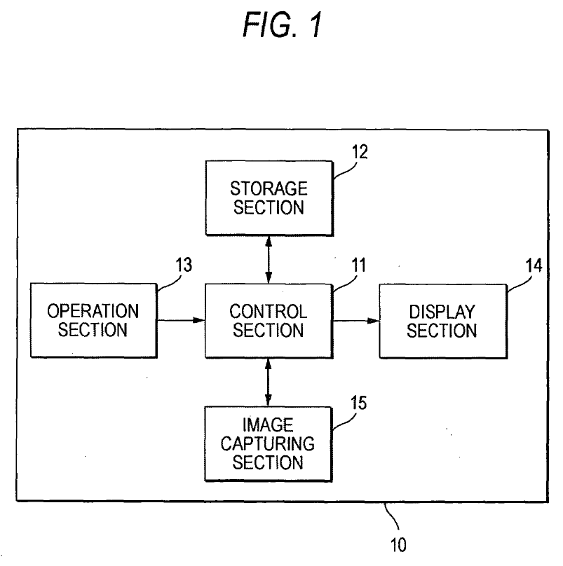

Referring now to the accompanying drawings, exemplary embodiments of the invention will be described below. An image processing apparatus 10 according to one exemplary embodiment of the invention includes a control section 11, a storage section 12, an operation section 13, a display section 14 and an image capturing section 15 as shown in FIG. 1.

The control section 11 may be a CPU, and operates in accordance with a program stored in the storage section 12. In the exemplary embodiment, the control section 11 controls the image capturing section 15, to thereby perform image processing of detecting marker image on a captured image obtained by capturing a target image. An example of the processing executed by the control section 11 will be described later in detail.

The storage section 12 may be a computer-readable storage medium for storing programs executed by the control section 11. The storage section 12 may include at least either of a memory device such as RAM and ROM, and a disk device. The storage section 12 also operates as work memory of the control section 11.

The operation section 13 may be implemented by operation buttons and a touch panel, for example. The operation section 13 outputs user's instruction operation to the control section 11. The display section 14 may be a display. The display section 14 displays information under the control of the control section 11.

The image capturing section 15, which may be a CCD camera, captures an image formed on a medium to be captured and outputs to the control section 11 image data of the captured image obtained by capturing the image.

The image capturing section 15 captures a target image containing plural marker images and a recognition target range identified by a marker-image set including at least parts of the marker images. The target image may contain more than one marker-image set and more than one recognition target range identified by a marker-image set. Also, each marker image is a pattern image having a predetermined shape. The marker images are placed in predetermined positions relative to the recognition target range in the target image. The marker image may be embedded by an electronic watermarking technology in the target image, in a form hard to recognize to human's eyes.

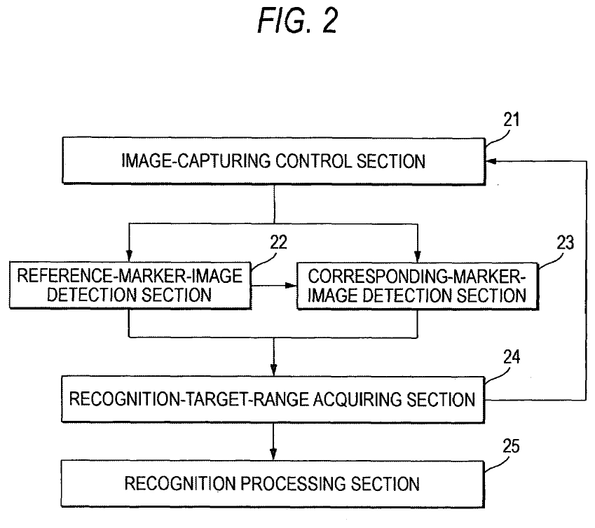

The image processing apparatus 10 functionally includes an image-capturing control section 21, a reference-marker-image detection section 22, a corresponding-marker-image detection section 23, a recognition-target-range acquiring section 24, and a recognition processing section 25, as shown in FIG. 2. The functions may be implemented in such a manner that the control section 11 executes the program stored in the storage section 12.

The image-capturing control section 21 controls the image capturing section 15 to acquire the captured image obtained by capturing the target image. The image-capturing control section 21 displays the acquired captured image on the display section 14 so as to present the captured image to the user. Further, the image-capturing control section 21 stores image data representing the captured image in the storage section 12 based on user's instruction operation through the operation section 13.

The image-capturing control section 21 may control the image capturing section 15 to change magnification and a focal distance of the image capturing section 15 based on user's instruction operation through the operation section 13 and a control instruction from the recognition-target-range acquiring section 24 described later.

The reference-marker-image detection section 22 performs image processing on the captured image acquired by the image-capturing control section 21, to thereby detect one of the marker images contained in the captured image as a reference marker image. Also, the reference-marker-image detection section 22 acquires a position and a size of the reference marker image in the captured image.

The reference-marker-image detection section 22 detects a marker image, for example, by the following processing and determines the detected marker image as the reference marker image. First, the reference-marker-image detection section 22 performs binarization processing on the captured image to acquire a binary image. Next, the reference-marker-image detection section 22 scans the binary image in a predetermined order starting at the upper left corner, for example, and extracts a connected image in which pixels of the binary image, which have a predetermined pixel value (1 bit or 0 bit) are connected. When extracting the connected image, the reference-marker-image detection section 22 performs marker-image judging processing of judging whether or not the connected image is a marker image. The reference-marker-image detection section 22 determines a connected image first judged as a marker image during the marker-image judging processing is the reference marker image.

The marker-image judging processing is performed, for example, as follows. First, the reference-marker-image detection section 22 judges whether or not the size of the extracted connected image is in a predetermined range. If judging that the size of the connected image is in the predetermined range, the reference-marker-image detection section 22 further performs matching processing between the extracted connected image and marker-image patterns stored in the image processing apparatus 10. Thereby, the reference-marker-image detection section 22 obtains a value indicating to what extent the marker image is similar to the extracted connected image (similarity degree). The reference-marker-image detection section 22 may perform the matching processing using a marker-image pattern, which has been subjected to a size correction in accordance with the size of the extracted connected image. If the similarity degree of the extracted connected image is equal to or greater than a predetermined threshold value, the reference-marker-image detection section 22 determines that the connected image is the marker image.

The corresponding-marker-image detection section 23 estimates a position of a corresponding marker image based on the position and size of the reference marker image detected by the reference-marker-image detection section 22. The corresponding marker image is a marker image, which is other than the reference marker image and is contained in at least one of marker-image sets containing the reference marker image.

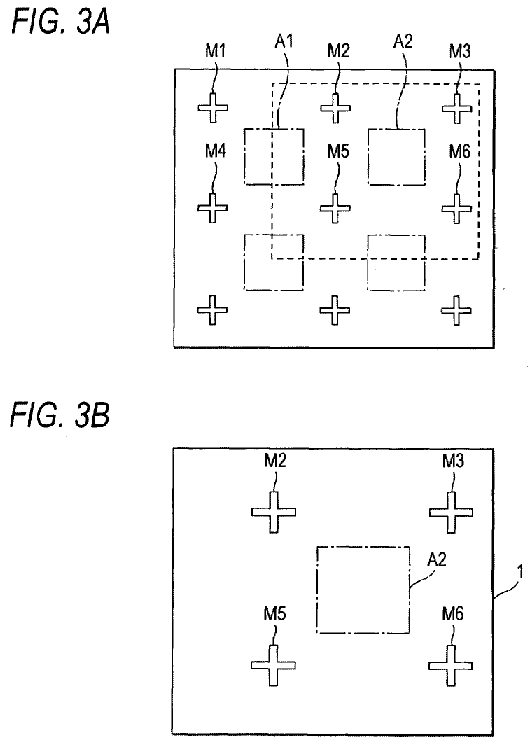

As a specific example, it is assumed that a target image contains (i) plural recognition target ranges in which the same target data is embedded by an electronic watermarking technology and (ii) plural marker-image sets, which define the respective recognition target ranges, as shown in FIG. 3A. In FIG. 3A, details of the target image except the marker images are not shown. In the example in FIG. 3A, marker images M1, M2, M4, and M5 make up a marker-image set S1, which defines a recognition target range A1. Also, marker images M2, M3, M5, and M6 make up a marker-image set S2, which defines a recognition target range A2. Each of the marker images M2 and M5 is contained in the plural marker-image sets.

In this case, it is assumed that the image capturing section 15 captures a range indicated by dashed lines in FIG. 3A, a captured image I shown in FIG. 3B is obtained. The reference-marker-image detection section 22 detects the marker image M2 as the reference marker image, for example. The corresponding-marker-image detection section 23 determines, based on the position of the reference marker image (the marker image M2), that the marker images M3, M5, and M6 located in the right, below, and lower right directions with respect to the reference marker image M2 are the corresponding marker images to be detected.

Here, the corresponding-marker-image detection section 23 determines the corresponding marker images to be detected (M3, M5 and M6) by estimating that the detected reference marker image (M2) is the marker image located in the upper left portion of the recognition target range (S1). However, the reference marker image is not always located in the upper left portion of the recognition target range. For example, the reference-marker-image detection section 22 may detect the marker image M3 as the reference marker image for the captured image I. In this case, the reference-marker-image detection section 22 may estimate the position of the reference marker image (M3) relative to the recognition target range (S1), based on the position of the detected reference marker image (M3) in the captured image (I), to thereby determine the corresponding marker images to be detected (M2, M5 and M6). For example, if detecting the reference marker image in the area of the right half in the captured image I, the reference-marker-image detection section 22 may determine that the marker images located in the left, below, and lower left directions with respect to the detected reference marker image are the corresponding marker images to be detected.

The corresponding-marker-image detection section 23 may estimate the position of each corresponding marker image specifically as follows. The corresponding-marker-image detection section 23 calculates a ratio Si/So of a predetermined size So of a marker image in the target image and a size Si of the detected reference marker image in the captured image. Then, the corresponding-marker-image detection section 23 multiplies a predetermined distance between a reference marker image in a target image and a corresponding marker image in the target image by the calculated ratio Si/So, to thereby calculate a distance between the reference marker image in the captured image and the corresponding marker image in the captured image. The corresponding-marker-image detection section 23 estimates a position of the corresponding marker image in the captured image based on the calculated distance and the position information of the reference marker image.

In the captured image I shown in FIG. 3B, let the position of the reference marker image be represented by coordinates (xs, ys), the distance between the marker images M2 and M3 in the target image be Lx and the distance between the marker images M2 and M5 be Ly. In this case, the corresponding-marker-image detection section estimates that the position of the marker image M3 in the captured image I is coordinates (xs+Lx·Si/So, ys), that the position of the marker image M5 is (xs, ys+Ly·Si/So), and that the position of the marker image M6 is (xs+Lx·Si/So, ys+Ly·Si/So).

In the above example, the corresponding-marker-image detection section 23 estimates the positions of the corresponding marker images M3, M5 and M6 with presuming that there is no distortion or inclination of the recognition target range A2 in the captured image I. However, if a lens of the image capturing section 15 is not parallel to the target image and the target image is captured in an inclination state, distortion or inclination may occur in the captured image I. In this case, the shape and the orientation of the reference marker image are detected, whereby parameters representing the distortion and inclination of the captured image I can be calculated. The corresponding-marker-image detection section 23 may execute rotation and/or geometric conversion of the captured image I according to the calculated parameters, to thereby correct the captured image I to a state of no distortion and no inclination to provide a corrected captured image. As a result, the corresponding-marker-image detection section 23 estimates the positions of the corresponding marker images in the corrected captured image by the method described above.

Further, the corresponding-marker-image detection section 23 detects the corresponding marker image based on the estimated position of the corresponding marker image. Specifically, like the reference-marker-image detection section 22, the corresponding-marker-image detection section 23 may extract a connected image contained in a predetermined range, which has the estimated position of the corresponding marker image in its center. Then, the corresponding-marker-image detection section 23 performs marker-image judging processing. Thereby, the corresponding-marker-image detection section 23 detects a marker image.

The recognition-target-range acquiring section 24 identifies and acquires the recognition target range contained in the captured image acquired by the image-capturing control section 21, based on the marker-image set made up of the reference marker image detected by the reference-marker-image detection section 22 and the corresponding marker images detected by the corresponding-marker-image detection section 23. Also, the recognition-target-range acquiring section 24 executes judging processing of judging whether or not the recognition target range contained in the captured image satisfies a predetermined condition required for performing recognition processing. The recognition-target-range acquiring section 24 may perform at least a part of the judging processing before identifying the recognition target range based on the reference marker image detected by the reference-marker-image detection section 22.

If the recognition target range cannot be acquired or if it is judged that the recognition target range does not satisfy the predetermined condition, the recognition-target-range acquiring section 24 executes predetermined processing of outputting guide information to a user. Accordingly, the user can know how he/she should correct the image pickup range and/or the distance to the target image, in order to capture the captured image containing the recognition target range under a desirable condition. As a result, user's convenience can be enhanced. Further, if the recognition-target-range acquiring section 24 can acquire the recognition target range so that the recognition target range satisfies the predetermined condition, the recognition-target-range acquiring section 24 may output guide information for presenting such a fact to the user.

The recognition-target-range acquiring section 24 may output guide information by displaying message information and a guide image representing a predetermined command description on the display section 14, for example. By way of example, the recognition-target-range acquiring section 24 may display an image of a frame representing the recognition target area to which recognition processing is applied as a guide image and may change the color of the guide image. Thereby, the recognition-target-range acquiring section 24 informs the user whether or not the recognition target range can be acquired.

If the recognition target range cannot be acquired or if it is judged that the recognition target range does not satisfy the predetermined condition, the recognition-target-range acquiring section 24 may output a control instruction for controlling the image capturing section 15 to the image-capturing control section 21. For example, if the recognition-target-range acquiring section 24 judges that the size of the recognition target range in the captured image is not in a predetermined range, the recognition-target-range acquiring section 24 may output a control instruction to the image-capturing control section 21 for changing magnification of the image capturing section 15 so that the size of the recognition target range is in the predetermined range.

Specifically, the recognition-target-range acquiring section 24 first acquires a size ratio of the captured image to the target image using the ratio Si/So of the size of the reference marker image detected by the reference-marker-image detection section 22 to the predetermined size of the reference marker image in target image. The recognition-target-range acquiring section 24 may judge whether or not the size of the recognition target range in the captured image is in the predetermined range by judging whether or not the acquired size ratio is in the predetermined range. Further, the recognition-target-range acquiring section 24 outputs a control instruction for changing magnification to the image-capturing control section 21 based on the acquired size ratio. In response thereto, the image-capturing control section 21 changes the magnification of the image capturing section 15. Thereby, The captured image is adjusted without user's explicit instructions so that the size of the recognition target range is in the predetermined range.

The recognition-target-range acquiring section 24 may judge whether or not the detected reference marker image is in focus and may output a control instruction to the image-capturing control section 21 for changing the focal distance of the image capturing section 15 based on the determination result.

The recognition processing section 25 executes recognition processing on the recognition target range acquired by the recognition-target-range acquiring section 24. As a specific example, if the recognition target range contains a text image, the recognition processing is processing of acquiring character code representing the text image. If the recognition target range contains a code image representing a bar code or a two-dimensional code, the recognition processing is processing of acquiring data represented by the code image by executing predetermined analysis processing. If the recognition target range is an image area in which target data is embedded by electronic watermarking technology, the recognition processing is processing of extracting the embedded target data by a method responsive to the electronic watermarking technology used in embedding the target data.

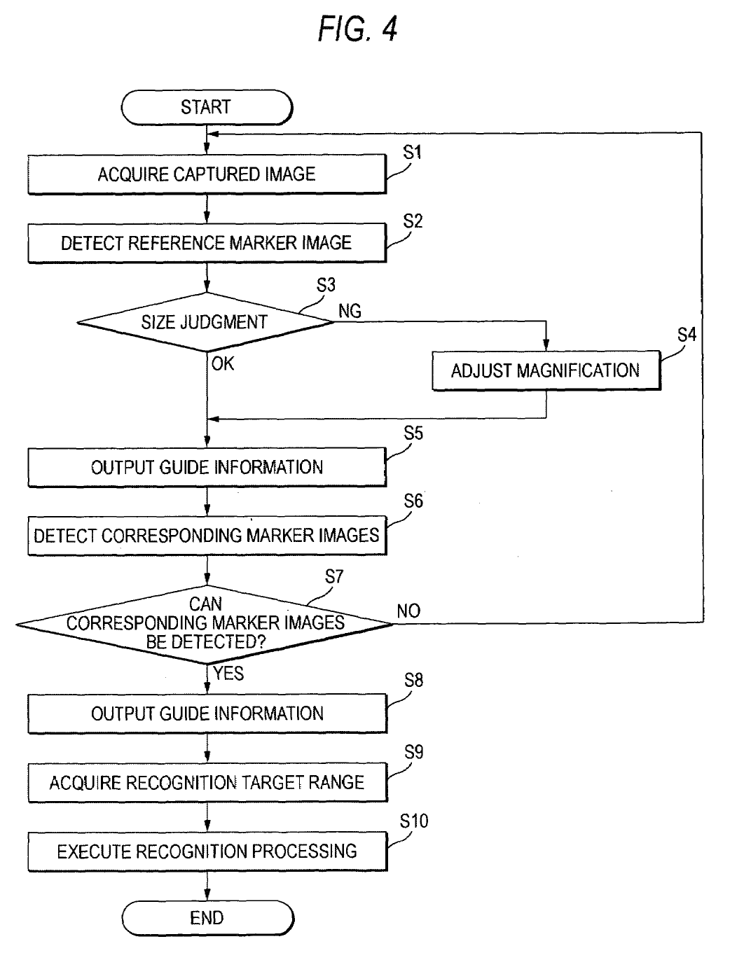

Next, an example of processing for the image processing apparatus 10 to capture the target image shown in FIG. 3A will be discussed based on a flowchart of FIG. 4.

First, the image-capturing control section 21 acquires a captured image by capturing the target image and displays the captured image on the display section 14 (S1). Subsequently, the reference-marker-image detection section 22 detects a reference marker image from the captured image acquired at S1 (S2). Here, it is assumed that the marker image M2 is detected as the reference marker image by way of example.

Next, the recognition-target-range acquiring section 24 executes size judging processing of judging whether or not the size of the recognition target range in the captured image is in a predetermined range, based on the size of the reference marker image detected at S2 (S3).

If the recognition-target-range acquiring section 23 judges at S3 that the size of the recognition target range is not in the predetermined range, the recognition-target-range acquiring section 24 outputs a control instruction to the image-capturing control section 21, to thereby execute adjustment processing of changing the magnification of the image capturing section 15 so that the size of the recognition target range is in the predetermined range (S4). Accordingly, the size of the recognition target range in the captured image will be in the predetermined range.

If the recognition-target-range acquiring section 23 judges at S3 that the size of the recognition target range is in the predetermined range or that the adjustment processing is completed in such a manner that the size of the recognition target range is in the predetermined range at S4, the recognition-target-range acquiring section 24 outputs guide information indicating such a fact (S5). Here, by way of example, the recognition-target-range acquiring section 24 changes the color of the guide image (e.g., a color of a frame) representing the recognition target range displayed on the display section 14 from red to orange, to thereby inform a user that the size of the recognition target range is in the predetermined range.

Subsequently, the corresponding-marker-image detection section 23 executes corresponding-marker-image detection processing of estimating positions of corresponding marker images based on the position and size of the detected reference marker image and detecting the corresponding marker images based on the estimated positions of the corresponding marker images (S6). Here, it is assumed that the corresponding-marker-image detection section 23 determines the marker images M3, M5, and M6 contained in the marker-image set S2 as the corresponding marker images, and is to detect the marker images.

Further, the recognition-target-range acquiring section 24 judges whether or not the corresponding marker images contained in the marker-image set, which includes the reference marker image and defines the recognition target range to be detect, can be detected (S7).

Here, if the three corresponding marker images of the marker images M3, M5, and M6 cannot be detected, this means that none of the marker images contained in the marker-image set S2 can be detected, and that the recognition target range A2 cannot be identified. Thus, the recognition-target-range acquiring section 24 does not output new guide information, and the color of the guide image remains orange. In this case, the user adjusts so that the entire recognition target range is contained in the captured image by moving the position of the image processing apparatus 10. Meanwhile, the image processing apparatus 10 returns to S1 and repeats the above-described processing until the corresponding marker images can be detected.

On the other hand, if the three corresponding marker images of the marker images M3, M5, and M6 are detected at S7, this means that the entire recognition target range A2 is contained in the captured image in a desirable size. In this case, the recognition-target-range acquiring section 24 outputs guide information indicating that the entire recognition target range A2 is contained in the captured image in the desirable size (S8). Here, by way of example, the color of the guide image of the frame is changed from orange to green, to thereby inform the user that a state has transitioned to another state in which the recognition target range A2 can be identified.

If the color of the guide image changes, the user acquires the recognition target range from the captured image and enters a recognition processing execution command by performing command entry operation of pressing a shutter button, for example, through the operation section 13. The recognition-target-range acquiring section 24 accepts the command from the user and acquires the recognition target range (S9). The recognition processing section 25 executes predetermined recognition processing on the recognition target range acquired by the recognition-target-range acquiring section 24 and outputs the result (S10).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus for capturing a target image containing a plurality of marker images and a recognition target range identified by a marker-image set including at least parts of the marker images, the image processing apparatus comprising:
an image capturing section that captures the target image to obtain a captured image;
a first detection section that detects one marker image as a reference marker image from the captured image;
a position estimation section that adopts a marker image, which is other than the reference marker image and is contained in at least one of marker-image sets containing the reference marker image, as a corresponding marker image, the position estimation section that estimates a position of the corresponding marker image in the captured image based on a size of the detected reference marker image; and
a second detection section that detects the corresponding marker image based on the estimated position of the corresponding marker image.

2. The image processing apparatus according to claim 1, wherein the second detection section corrects at least one of distortion and inclination of the captured image based on at least one of a shape and an orientation of the reference marker image before detecting the corresponding marker image.

3. An image processing apparatus for capturing a target image containing at least one marker image, the image processing apparatus comprising:
an image capturing section that captures the target image to obtain a captured image;
a detection section that detects the marker image from the captured image;
a determination section that determines based on a size of the detected marker image whether or not a size of a recognition target range, which is contained in the target image, in the captured image is in a predetermined range; and
an output section that outputs information in accordance with a determination result.

4. The apparatus according to claim 3, further comprising:
an adjustment section that changes, in accordance with the determination result, a magnification of the image capturing section so that the size of the recognition target range in the captured image is in the predetermined range.

5. The apparatus according to claim 3, wherein the information output by the output section includes guidance information to a user of the apparatus for capturing the target image.

6. An image processing method for capturing a target image containing a plurality of marker images and a recognition target range identified by a marker-image set including at least parts of the marker images, the method comprising:
capturing the target image to obtain a captured image;
detecting one marker image as a reference marker image from the captured image;
adopting a marker image, which is other than the reference marker image and is contained in at least one of marker-image sets containing the reference marker image, as a corresponding marker image;
estimating a position of the corresponding marker image in the captured image based on a size of the detected reference marker image; and
detecting the corresponding marker image based on the estimated position of the corresponding marker image.

7. The method according to claim 6, further comprising:
before the detecting of the corresponding marker image, correcting at least one of distortion and inclination of the captured image based on at least one of a shape and an orientation of the reference marker image.

8. A computer readable medium storing a program causing a computer to execute a process for capturing a target image containing a plurality of marker images and a recognition target range identified by a marker-image set including at least parts of the marker images, the process comprising:
capturing the target image to obtain a captured image;
detecting one marker image as a reference marker image from the captured image;
adopting a marker image, which is other than the reference marker image and is contained in at least one of marker-image sets containing the reference marker image, as a corresponding marker image;
estimating a position of the corresponding marker image in the captured image based on a size of the detected reference marker image; and
detecting the corresponding marker image based on the estimated position of the corresponding marker image.

9. The computer readable recording medium according to claim 8, wherein the process further comprises:
before the detecting of the corresponding marker image, correcting at least one of distortion and inclination of the captured image based on at least one of a shape and an orientation of the reference marker image.

10. A computer data signal embodied in a carrier wave for enabling a computer to perform a process for capturing a target image containing a plurality of marker images and a recognition target range defined by a marker-image set including at least parts of the marker images, the process comprising:
capturing the target image to obtain a captured image;
detecting one marker image as a reference marker image from the captured image;
adopting a marker image, which is other than the reference marker image and is contained in at least one of marker-image sets containing the reference marker image, as a corresponding marker image;
estimating a position of the corresponding marker image in the captured image based on a size of the detected reference marker image; and
detecting the corresponding marker image based on the estimated position of the corresponding marker image.

11. The computer data signal according to claim 10, wherein the process further comprises:
before the detecting of the corresponding marker image, correcting at least one of distortion and inclination of the captured image based on at least one of a shape and an orientation of the reference marker image.
